(19) United States
(12) Patent Application Publication
(10) Pub. No.: US 2019/0023863 A1
(43) Pub. Date: Jan. 24, 2019

(54) IMPACT MODIFIED COMPOSITIONS METHODS OF MANUFACTURE THEREOF AND ARTICLES COMPRISING THE SAME

(71) Applicants: UNIVERSITY OF MASSACHUSETTS, Boston, MA (US); BASF SE, Ludwigshafen (DE)

(72) Inventors: Alan James LESSER, Shutesbury, MA (US); Gregory Connor EVANS, Sunderland, MA (US); Philippe DESBOIS, Ludwigshafen (DE)

(21) Appl. No.: 15/748,735

(22) PCT Filed: Jul. 29, 2016
(86) PCT No.: PCT/US16/44789

§ 371 Date: Jan. 30, 2018

Related U.S. Application Data
(60) Provisional application No. 62/198,699, filed on Jul. 30, 2015.

(51) Int. Cl. C08J 9/28; C08J 5/02; C08L 83/04; C08L 77/02

(52) U.S. Cl. CPC C08J 9/283; C08J 5/02; C08L 83/04; C08J 2300/24; C08J 2383/04; C08J 2477/02; C08J 2300/22; C08L 77/02

(57) ABSTRACT

Disclosed herein is an impact modified composition comprising a first polymer; and a second polymer that is dispersed in the first polymer; where the first polymer and the second polymer are melt polymerized in each other's presence, are phase separated from each other after polymerization; are not reactively bonded with each other; and where a precursor to the first polymer and to the second polymer are soluble in one another prior to polymerization. Disclosed herein too is a method comprising melt polymerizing a first monomer and a second monomer in the presence of each other to form a first polymer and a second polymer; where the first monomer and the second monomer are soluble in each other; where first polymer and the second polymer are phase separated from each other with the second polymer being dispersed in the first polymer; where the first polymer and the second polymer are not reactively bonded to each other.

### CROSS REFERENCE TO RELATED APPLICATIONS

This application is a National Stage application of PCT/US2016/044789, filed Jul. 29, 2016, which claims the benefit of U.S. Provisional Application No. 62/198,699, filed Jul. 30, 2015, both of which are incorporated by reference in their entirety herein.

### BACKGROUND

This disclosure relates to impact modified compositions, to methods of manufacturing these compositions and to articles comprising the same.

The technology associated with impact modification of polymers is well established. One major area of this technology involves the use of soft or rubber particles to generate advanced toughened polymer materials. Two common commercial rubber toughened polymers are high-impact polystyrene (HIPS) and acrylonitrile butadiene styrene (ABS). Both of these rubber toughened polymers comprise at least one rigid phase (polystyrene) and an elastomeric (rubber) phase (polybutadiene). Butadiene rubber is introduced into both of these materials through both melt blending and graft polymerization. Other polymers that have been rubber toughened include poly(methyl methacrylate) (PMMA), polyvinyl chloride (PVC), polypropylene (PP), and epoxy resins, to name a few.

Important parameters for these materials include the rigid phase modulus, rubber phase modulus, rubber particle size, rubber particle loading, distance between rubber particles, and adhesion between rigid and rubber phases. For this class of materials, the morphology consists of dispersed rubber particles embedded within a more rigid matrix. Both the size and concentration suitable for effective impact performance is material dependent. However, general concentration ranges have been identified for a broad range of systems. Typically, the concentration of rubber particles is observed between 1 weight percent (wt %) and 20 wt %. For a given concentration, the particle size dictates the inter-particle distance. The particle size is also material dependent but most systems show the best performance when domain sizes are in a range between 0.1 micrometer (μm) and 10 μm.

It is well established that the proper dispersion of soft rubber particles can significantly increase the energy absorbed during fracture and failure of polymers. It does so by changing the failure mode from one that is initially brittle to one that is far more ductile in nature. This occurs because the particles delocalize the fracture event, release hydrostatic stresses in the vicinity of the crack tip and allow for the matrix material to deform in a more unconstrained state of stress. After particle cavitation (which relieves hydrostatic stress) the micromechanisms for matrix deformation include crazing, inelastic void growth, shear banding, and fracture.

It has also been demonstrated that rubber particles and voids of similar sizes display similar toughening processes. This result suggests that toughening can be achieved through void formation in addition to rubber particle dispersion.

Impact modification of polymeric materials polymerized from a monomer melt (e.g., anionically polymerized polyamides) is more complex than that of other common polymers. The impact modifier is selected such that it is compatible with the existing polymerization chemistry. Dispersion of rubber particles in melt polymerized materials has been performed, however, issues including an increase in process viscosity, particle agglomeration, and homogenous particle dispersion reduce the viability of such products.

It is therefore desirable to arrive at a method whereby melt polymerized polymeric materials can be suitably impact modified so that they do not display the aforementioned problems.

### SUMMARY

Disclosed herein is an impact modified composition comprising a first polymer; and a second polymer that is dispersed in the first polymer; where the first polymer and the second polymer are melt polymerized in each other's presence, are phase separated from each other after polymerization; are not reactively bonded with each other; and where a precursor to the first polymer and to the second polymer are soluble in one another prior to polymerization.

Disclosed herein too is a method comprising melt polymerizing a first monomer and a second monomer in the presence of each other to form a first polymer and a second polymer; where the first monomer and the second monomer are soluble in each other; where first polymer and the second polymer are phase separated from each other with the second polymer being dispersed in the first polymer; where the first polymer and the second polymer are not reactively bonded to each other.

### BRIEF DESCRIPTION OF THE FIGURES

FIG. 1(A) shows a scanning electron microscopy micrographs that depicts the morphology of cryo-fractured surfaces of the impact modified composition of a control polyamide 6 with no D4;

FIG. 1(B) shows a scanning electron microscopy micrographs that depicts the morphology of cryo-fractured surfaces of the impact modified composition of polyamide 6 with 1 wt % D4;

FIG. 1(C) shows a scanning electron microscopy micrographs that depicts the morphology of cryo-fractured surfaces of the impact modified composition of polyamide 6 with 2 wt % D4;

FIG. 1(D) shows a scanning electron microscopy micrographs that depicts the morphology of cryo-fractured surfaces of the impact modified composition of polyamide 6 with 4 wt % D4;

FIG. 2(A) shows DSC first heating and cooling of the polyamide 6 with D₄ samples:

FIG. 2(B) shows DSC second heating and cooling of the polyamide 6 with D₄ samples; and

FIG. 3 is a graph showing infra-red data of a polyamide 6 with 20 wt % D₄ at 150° C. as well as samples and reagents.

### DETAILED DESCRIPTION

The term “oligomer” or “oligomeric” as defined herein is a polymer that has up to 20 repeat units. In general, oligomers have number average molecular weights of less than 10,000 grams per mole. The oligomer may be a linear polymer, a branched polymer or a crosslinked polymer.

The term “polymeric material” as used herein refers to the material that is polymerized ionically to form the polymer.

Disclosed herein is an impact modified polymeric composition (hereinafter polymeric composition) that is produced by simultaneously melt polymerizing two monomers into two polymers that are phase separated from each other such that one of the phases is dispersed in the other. The method comprises co-reacting a first monomer with a second monomer to form a phase separated first polymer and second polymer. In other words, the method comprises reacting a first monomer to form a first polymer in the presence of a second monomer, which is also reacted to form a second polymer. The second monomer is soluble in the first monomer, preferably when both are in the melt state prior to polymerization. Once the reaction has occurred in the melt state, the second polymer is phase separated from the first polymer (i.e. the second polymer is insoluble in the first polymer and vice versa) and serves to impact modify the first polymer. This method is advantageous in that the reactants do not boil or create volatile products during the reaction. Neither the first monomer nor the first polymer is reacted with the second monomer or the second polymer during polymerization and the first polymer and the second polymer do not form an interpenetrating network.

It is to be noted that the first monomer is chemically different from the second monomer and the first polymer is chemically different from the second polymer.

The method of reacting two monomers in the presence of one another to form two phase separated polymers produces a composition that displays superior impact properties when compared with the impact properties of either of the two individual polymers. Laboratory experiments show a 3 to 10, preferably a 4 to 7-fold increase in fracture toughness through the incorporation of small amounts of the second polymer in the first polymer.

The melt polymerized polymers include thermoplastic polymers or crosslinked polymers (sometimes referred to as thermosetting polymers). The resulting impact modified composition that contains the melt polymerized first polymer and the second polymer may be a thermoplastic composition, a thermosetting composition, or a blend of a thermoplastic composition with a thermosetting composition. Blends of thermoplastic compositions and thermosetting compositions may also be used in the impact modified composition.

The first polymer obtained from melt polymerization include an oligomer, a homopolymer, a copolymer, a block copolymer, an alternating block copolymer, a random polymer, a random copolymer, a random block copolymer, a graft copolymer, a star block copolymer, a dendrimer, a polyelectrolyte (polymers that have some repeat groups that contain electrolytes), a polyampholyte (a polyelectrolyte having both cationic and anionic repeat groups), an ionomer, or the like, or a combination comprising at last one of the foregoing organic polymers.

Examples of the thermoplastic melt polymerized first polymers suitable for use in the polymeric composition are polyacetals, polyolefins, polyacrylics, polycarbonates, polystyrenes, polyesters, polyamides, polyamideimides, polyarylates, polyarylsulfones, polyethersulfones, polyphenylene sulfides, polyvinyl chlorides, polysulfones, polyimides, polyetherimides, polyfluoroethylenes, polyetherketones, polyether etherketones, polyether ketone ketones, polybenzoxazoles, polyphthalides, polyacetals, polyanhydrides, polyvinyl ethers, polyvinyl thioethers, polyvinyl alcohols, polyvinyl ketones, polyvinyl halides, polyvinyl nitriles, polyvinyl esters, polysulfonates, polysulfides, polythioesters, polysulfones, polysulfonamides, polyureas, polyphosphazenes, polysilazanes, or the like or a combination thereof.

Examples of thermosetting first polymers suitable for use in the polymeric composition include epoxy polymers, unsaturated polyester polymers, polyimide polymers, bismaleimide polymers, bismaleimide triazine polymers, cyanate ester polymers, vinyl polymers, benzoxazine polymers, benzocyclobutene polymers, acrylics, alkyds, phenol-formaldehyde polymers, novolacs, resoles, melamine-formaldehyde polymers, urea-formaldehyde polymers, hydroxymethylfurans, isocyanates, diallyl phthalate, triallyl cyanurate, triallyl isocyanurate, unsaturated polyesterimides, or the like, or a combination comprising at least one of the foregoing thermosetting polymers.

An exemplary first polymer is a thermoplastic polyamide. In an embodiment, the melt polymerization of the polyamides is achieved via ionic polymerization. The polyamides are obtained via anionic or cationic polymerization, preferably anionic polymerization.

It is desirable for the polyamides to be melt polymerized from cyclic lactams. In this method, high molecular weight polyamides are polymerized from lactams containing from 3 to 14 or more carbon atoms in the lactam ring. Such lactams include pyrrolidone, piperidone, caprolactam, enantholactam, caprylolactam, and laurolactam. Generally in the presence of a co-catalyst (activator), the anionic polymerization process of a lactam is carried out at temperatures above the melting point of the lactam monomer but below the melting point of the resulting polyamide. In general, this temperature is 25° C. to 220° C., depending on the particular lactam employed. With lactams containing less than 6 carbon atoms in the lactam ring, the preferred temperature of polymerization is below 190° C. Caprolactam is readily polymerized at temperatures of 100° C. to 220° C., with 160° C. being a convenient operating temperature. In the preparation of the polyamides, iminium salts are first prepared by the reaction of bases with a lactam. Generally, the lactam to be polymerized is used for the preparation of the anionic catalyst; but if desired, the anionic catalyst can be prepared from another lactam.

The substances employed to form the anionic catalyst can be an alkali metal, an alkaline earth metal, aluminum, or a basic derivative of one of these metals, such as a hydroxide, alkoxide, hydride, aryl, amide, or organic acid salt. All of these substances are strong enough to convert the lactam to its iminium salt. Thus, sodium hydroxide, potassium hydroxide, lithium hydroxide, magnesium hydroxide, calcium hydroxide, strontium hydroxide, lithium hydride, sodium hydride, sodium methylate, sodium ethylate, sodium phenolate, sodium beta-naphtholate, sodamide, sodium stearate, lithium aluminium hydride, aluminium propylate, or the like, or combinations thereof are suitable substances for the preparation of the anionic catalyst. This anionic catalyst, that is, lactam-base salt, is prepared by heating the lactam with the aforesaid substances at temperatures of 25° C. to 220° C. The aforementioned substances can be added to the total lactam which is to be polymerized or to a portion of it in order to prepare the anionic catalyst.

The latter can be added to the remainder of the lactam later. Little or no polymerization occurs during the preparation of the anionic catalyst. The time used for the preparation of the anionic catalyst depends upon the properties of the substances employed, the quantity added, and the temperature chosen and generally can be from a few seconds to several hours. Preferably, the lactam should be essentially as anhydrous as the added substance. The ratio of the substance to be added usually is 0.1 to 10 mole percent based on the lactam, which is desirable to conduct the polymerization. The higher the ratio of the activator to lactam, the lower is the molecular weight of the polyamides which can be obtained. Consequently, the optimum proportions for most purposes are from about 0.1 to about 5 mole percent based on the total number of moles of lactam and catalyst.

Co-catalysts may be employed in proportions varying from about 0.1 to about 5 mole percent based on the lactam. At any time when polymerization is desired, the co-catalyst can be added to the lactam containing the anionic catalyst. Otherwise, the anionic catalyst and co-catalyst can be separately dissolved in two portions of the total lactam and subsequently mixed together. For optimum operation, an inert gas such as, nitrogen, is introduced onto the surface of the molten lactam during the reaction to prevent oxidation.

In one embodiment, the process of melt polymerizing the first monomer is conducted in the presence of a second monomer. The second monomer may also undergo polymerization to form a second polymer that ends up being dispersed in the first polymer. The second polymer is an amorphous polymer that may be an oligomer or a homopolymer. It lies above its glass transition temperature at room temperature. It may be a thermoplastic polymer or a crosslinked polymer. The first polymer and the second polymer are also not in the form of interpenetrating networks. The second polymer is a homopolymer. It is not a copolymer.

The second polymer contains no reactive end-group (a live end group) is not covalently bonded with the first polymer. There is no covalent or ionic reaction between the second polymer and first polymer in which it is dispersed.

The second polymer generally comprises an elastomer such as polybutadiene, polyisoprene, polydiorganosiloxane, polychloroprene, or a combination thereof.

An exemplary second polymer is a polydiorganosiloxane. The polydiorganosiloxane may have a cyclic structure or a linear structure. Cyclic polydiorganosiloxanes and linear polydiorganosiloxanes are shown below in the formula (1). The polydiorganosiloxane (also referred to herein as “polysiloxane”) blocks of the copolymer comprise repeating diorganosiloxane units as in formula (1)

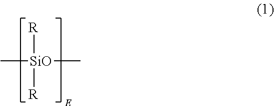

wherein each R is independently a C₁₋₁₃ monovalent organic group. For example, R can be a C₁-C₁₃ alkyl, C₂-C₁₃ alkenyl group, C₃-C₆ cycloalkyl, C₆-C₁₄ aryl, C₇-C₁₃ arylalkyl, or C₇-C₁₃ alkylaryl, or a combination thereof.

The value of E in formula (1) is less than 30, preferably 2 to 18, and more preferably 3 to 10. In an exemplary embodiment, the polydiorganosiloxane is cyclic and has 3 to 6 repeat units. The number of repeat units is indicated by the suffix accompanying the letter D. For example, a cyclic polydimethylsiloxane having E=4 is termed D₄ while a cyclic polysiloxane having E=8 is termed D₈.

In one embodiment, the second polymer is a polydiorganosiloxane (such as polydimethylsiloxane) oligomer having up to 40 repeat units, preferably up to 30 repeat units, preferably up to 20 repeat units, and preferably as little as 4 repeat units.

In another embodiment, the second polymer may be crosslinked. In other words, the second polymer can be a polydiorganosiloxane that is crosslinked.

Examples of organosiloxanes that can yield the polydiorganosiloxane are hexamethylcyclotrisiloxane, octamethylcyclotetrasiloxane, decamethylcyclopentasiloxane, octaphenylcyclotetrasiloxane, 1,3,5,7-tetravinyl-1,3,5,7-tetramethoxysilane, (3,3,3-Trifluoropropyl)methylcyclotrisiloxane, and combinations thereof.

In one embodiment, the composition comprises 12 wt % or less, specifically 7 wt % or less, and more specifically 5 wt % or less, of the second polymer based on the total weight of the impact modified composition.

In one embodiment, in one manner of manufacturing the polymeric composition, the first monomer and the second monomer and any desirable additives and fillers may generally be taken in a reaction vessel and polymerized using the catalysts detailed above. The impact modified polymeric composition may be produced in a batch or continuous process by melt blending.

Melt blending of the impact modified composition involves the use of shear force, extensional force, compressive force, ultrasonic energy, electromagnetic energy, thermal energy or combinations comprising at least one of the foregoing forces or forms of energy and is conducted in processing equipment wherein the aforementioned forces or forms of energy are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, or combinations comprising at least one of the foregoing.

Melt blending involving the aforementioned forces may be conducted in machines such as single or multiple screw extruders, Buss kneader, Henschel, helicones, Ross mixer, Banbury, roll mills, molding machines such as injection molding machines, vacuum forming machines, blow molding machine, or the like, or combinations comprising at least one of the foregoing machines.

As detailed above, when manufacturing an impact modified polyamide-polysiloxane composition, blending comprises mixing the lactam solution containing the anionic catalyst and a second portion of the lactam solution containing the co-catalyst and then casting the resulting solution into a mold. The second monomer may be added to the lactam solution containing the anionic catalyst and a second portion of the lactam solution containing the co-catalyst followed by disposing the solution into a mold to form the impact modified composition.

The ionically polymerized first polymer of the polymeric composition can have a weight average molecular weight of 2,000 to 100,000 Daltons, specifically 5,000 to 50,000 Daltons as measured by gel permeation chromatography. The first polymer is present in the impact modified composition in amounts of 80 to 99 wt %, preferably 85 to 98 wt %, and more preferably 95 to 97 wt % based on the total weight of the impact modified composition.

The process can be conducted in the presence of various additives. Thus, if desired, glass mats or mats of synthetic fibers can be impregnated and then polymerized. Similarly, finely-divided fillers can be suspended in the polymerizing mixture to obtain filled polyamides. Antioxidants, blowing agents, plasticizers, other resins (e.g., polystyrene, polyvinyl chloride, polyacetal, polyester, and the like), colorants, and the like can also be employed as additives.

The addition of the second polymer shows no apparent detriment to the properties of the first polymer (e.g., the polyamide). It does not negatively alter the crystalline behavior of the first polymer, and does not significantly affect other mechanical properties of the polymer including elastic modulus and yield strength. The addition of the second polymer to the first polymer increases the flame resistance and the lubricity of the impact modified polymeric composition.

In the case of the impact modified polyamide-polysiloxane copolymers, the composition produced from the anionic polymerization of lactams and the polymerization of cyclic or monomeric siloxanes have a micro-phase separated morphology and exhibit dramatically increased fracture toughness without compromising stiffness or yield. Components of the reaction mixture include the first monomer, the second monomer, activator, and respective catalysts (or a single catalyst if it can polymerize both the first and the second monomer). The first monomer may consist of cyclic lactams for production of polyamide 4 through polyamide 14. The second monomer comprises low molecular weight (monomeric or cyclic) organosiloxanes that are soluble in the caprolactam melt. Activators often comprise an acetyl functionalized lactam derivative. Catalyst comprises an anionic salt commonly based upon sodium, lithium, or magnesium. The polymerization is performed in a melt mixture of all chemicals and the temperature may vary from 90 to 220° C.

The polymerization is performed in an inert atmosphere to prevent the fouling of catalyst with water or other impurities. During the melt lactam polymerization, cyclic lactam chemicals are converted to solid polyamide polymer. The organosiloxane monomer is soluble in the lactam and insoluble in the polyamide. As the anionic polymerization proceeds, the organosiloxane reacts to form polydiorganosiloxane which phase separates due to depletion of the melt lactam. Phase separation occurs at high viscosities creating a homogenously dispersed micro-phase separated morphology. These phase separated domains consist primarily of the polydiorganosiloxane. Additionally, the polydiorganosiloxane additive undergoes reactions after phase separation such that a high molecular weight viscous liquid or a percolated cross-linked network may be produced.

This process is advantageous in that melt anionically polymerized polyamides have been identified as being mechanically superior to polyamides that having been hydrolytically polymerized or molded from the melt. Higher crystallinity is obtained through the anionic polymerization process that is lost through the process of melting. Polyamides produced from the anionic polymerization of lactams have a much more mechanically desirable crystal structure than melt processed polyamides. Anionic polymerization is extremely sensitive to impurities such that potential fillers and reinforcing agents are restricted based on their interaction with the catalyst.

The process is useful in rapidly preparing cast articles of any size and shape directly from lactams. An exemplary method of casting articles is via reaction injection molding. The process has advantages when used in the manufacture of large molded articles, because injection molding or similar processes use high temperatures and high pressures for their operations. Therefore, simpler and lighter weight molds can be employed and faster cycles can often be obtained in the manufacture of large shaped articles. The entire process can be carried out in the mold or, if desired, the lactam solution containing the anionic catalyst and a second portion of the lactam solution containing the co-catalyst can be mixed and then immediately cast into the mold by procedures similar to those of transfer molding so as to obtain the desired, shaped article in any size and at a very high rate. The molded product is a polyamide.

Similarly, it is possible to employ the process in many extrusion type operations, in which the lactam containing the anionic catalyst and other portion of the lactam containing the co-catalyst are intimately mixed and then extruded under conditions which provides for obtaining an extrudate which is formed immediately following the polymerization process. The extrudate is a polyamide.

The method of manufacturing the impact modified composition and the methods detailed herein are exemplified by the following non-limiting examples.

### Example

This example is conducted to demonstrate that impact modified compositions can be manufactured by the aforementioned method where an oligomer is added to the reaction mixture containing lactams that are polymerized to form polyamides.

Preliminary work has been performed at 130° C. in a N₂ atmosphere using ε-caprolactam as the monomer, Bruggolen C20 as the activator, Burggolen C10 as the catalyst, and octamethyltetrasiloxane (D₄) as the siloxane additive. Additional siloxane additives including linear and cyclic oligomers have been observed to perform similarly to D₄. Characterization of the impact modified material has been performed using scanning electron microscopy (SEM), differential scanning calorimetry (DSC), density, compression testing, and compact tension fracture testing, attenuated total reflectance Fourier transform infrared spectroscopy (ATR-FTIR). The structure of the various reactants and the polyamide product are shown below.

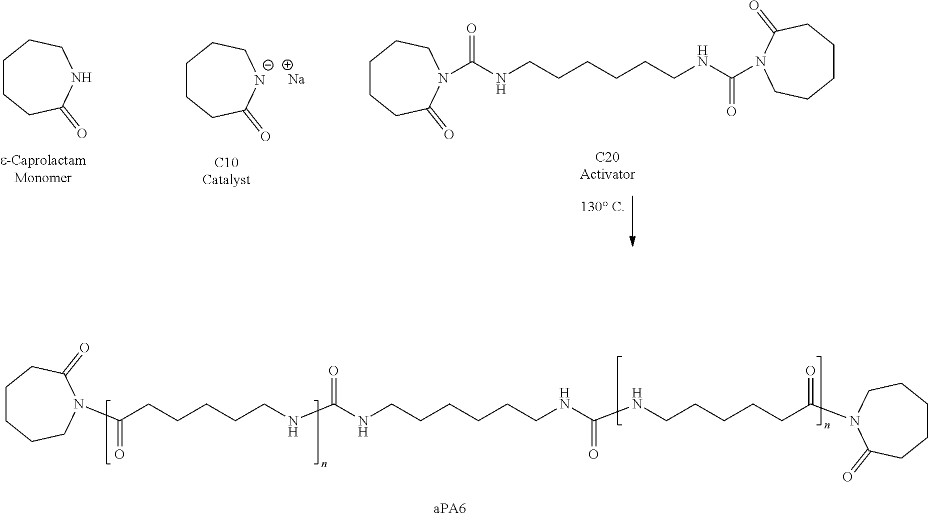

The reaction has been observed visually for indications of phase separation and reaction rate. Time to gelation is defined as the time from catalyst addition to the time at which the stir-bar mixing the reaction mixture ceases to spin. Time of gelation has been observed for mixtures at 130° C. as ˜200 seconds and at 150° C. as ˜45 seconds. Reaction temperature has been observed to increase up to 40° C. after addition of catalyst due to the exothermic polymerization. Homopolymer reaction mixtures are visually clear prior to gelation and yellowish white at reaction completion. Reaction mixtures containing the polydiorganosiloxane additive are visually clear until the point of phase separation at which the mixture becomes cloudy and white then yellowish white at reaction completion.

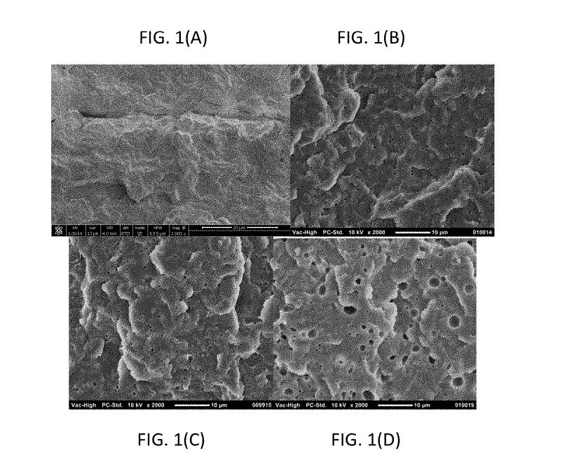

Scanning electron microscopy (SEM) (ASTM F1877) is performed to observe the morphology of cryo-fractured surfaces as in FIGS. 1(A)-1(D). Voids or particles are observed to be homogenously distributed throughout the sample and to be relatively monodisperse in samples containing 1 wt % D₄ and 2 wt % D₄. FIG. 1(A) is a photograph that shows a sample that is not impact modified. FIG. 1(B) is a photograph that shows a fractured sample surface that contains 1 wt % D4. FIG. 1(C) shows a fractured sample surface that contains 2 wt % D4. FIG. 1(D) shows a fractured sample surface that contains 4 wt % D4. Manually measured void diameter averages 0.7 micrometers (μm) for 1 wt % D₄, 0.3 μm for 2 wt % D₄, and 0.5 μm for 4 wt % D₄. The area fraction voided is 0.04 for 1 wt % D₄, 0.04 for 2 wt % D₄, and 0.11 for 4 wt % D₄. The polymer in all of the FIGS. 1(A)-1(D) are polyamide 6.

In summary, the samples containing the D₄ have void diameters that range from 0.2 to 2, preferably 0.3 to 1.0, and more preferably 0.4 to 0.8 micrometers. The area void fraction as determined from scanning electron microscopy is 0.02 to 0.15, preferably 0.03 to 0.13 and more preferably 0.04 to 0.11 percent, based on a total cross-sectional area of a fractured surface when it is fractured at a temperature below its glass transition temperature.

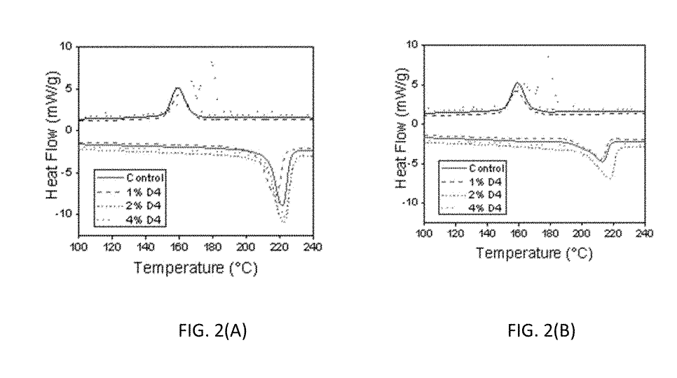

Differential Scanning Calorimetry (DSC) (ASTM D3418) is performed to verify the integrity of the polyamide 6 crystal structure and percent crystallinity. The data is shown in the FIG. 2 and in the Table 1. FIG. 2 shows DSC first heating and cooling of the polyamide 6 with D₄ samples (left), second heating and cooling of the polyamide 6 with D₄ samples.

TABLE 1

| | 1^{st} Cycle | | | | | 2^{nd} Cycle | | | | |
|---|---|---|---|---|---|---|---|---|---|---|
| | Heating | | | Cooling | | Heating | | | Cooling | |
| | T_{g} | Tₘ | ΔHₘ | T_{c} | ΔH_{c} | T_{g} | Tₘ | ΔHₘ | T_{c} | ΔH_{c} |
| Sample | (° C.) | (° C.) | (J/g) | (° C.) | (J/g) | (° C.) | (° C.) | (J/g) | (° C.) | (J/g) |
| Control | 46 | 221 | 82 | 159 | 54 | 26 | 213 | 53 | 159 | 57 |
| 1 wt % D4 | 50 | 217 | 96 | 160 | 51 | 29 | 212 | 52 | 158 | 55 |
| 2 wt % D4 | 47 | 222 | 86 | 178 | 63 | 46 | 217 | 66 | 177 | 67 |
| 4 wt % D4 | 52 | 222 | 87 | 166 | 52 | 26 | 211 | 56 | 162 | 54 |

The anionically polymerized polyamide 6 structure is verified in the first melting endotherm of all samples. Higher crystallinity is observed in D₄ containing samples despite the added additive mass as seen in the Table 1 above. This result suggests that the presence of D₄ enhances the crystallization process of the polyamide 6 during synthesis. The increase in crystallinity may lead to improvement in modulus and yield strength in the final material.

Density (ASTM D792) is measured through a water displacement pycnometer method as listed in Table 2. Decrease in density is observed as expected due to the siloxane phases.

TABLE 2

| Sample | Density (g/cm³) |
|---|---|
| Control | 1.149 |
| 1 wt % D4 | 1.142 |
| 2 wt % D4 | 1.141 |
| 4 wt % D4 | 1.133 |

Compression (ASTM D695) samples have been performed to measure the modulus and yield of the materials as outlined in Table 3. Compression samples consisted of cylinders machined from the sample bulk with a height to width ratio of 1:1 and were tested at a strain rate of 0.001. Little loss of modulus or yield stress was observed in samples containing D₄.

Compact tension fracture toughness tests (ASTM 5045) were performed to measure the fracture toughness as outlined in Table 4. Compact tension samples were machined from the sample bulk. Non-linear fracture toughness calculations were used to calculate the fracture toughness of each sample. A five-fold increase in fracture toughness was observed in some D₄ containing samples.

TABLE 3
Compressive modulus and yield stress
of the polyamide 6 with D₄ samples

| Sample | Modulus (MPa) | Yield Stress (MPa) |
|---|---|---|
| aP A6 Control | 3100 | 92 |
| 1% D4 | 3000 | 94 |
| 2% D4 | 3100 | 91 |
| 4% D4 | 2800 | 89 |

TABLE 4
Non-linear fracture toughness of the polyamide 6 with D₄ samples

| Sample | J_{q} (kJ/m) |
|---|---|
| Control | 9 |
| 1% D4 | 43 |
| 2% D4 | 53 |
| 4% D4 | 37 |

From the Tables 3 and 4 it may be seen that the impact modified compositions have a compressive modulus of 2500 to 3500 MPa preferably 2700 to 3300 MPa and a yield stress of 85 to 100, preferably 88 to 95 MPa. The fracture toughness is 10 to 100 kilojoules per meter, preferably 35 to 60 kilojoules per meter.

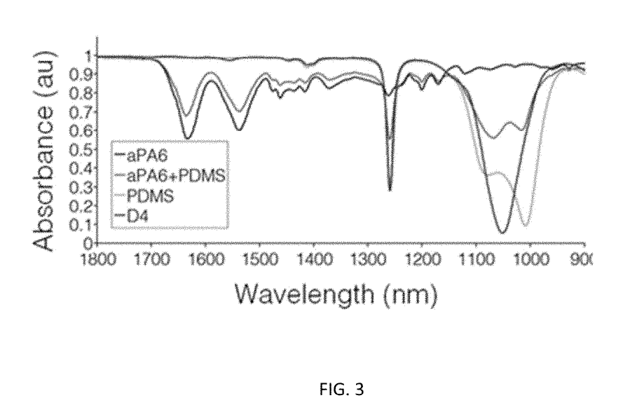

Attenuated total reflectance-infra-red (ATR-IR) (ASTM E1252) spectrometry was performed to analyze the material chemistry as outlined in FIG. 3. FIG. 3 is a graph showing infra-red data of a polyamide 6 with 20 wt % D₄ at 150° C. as well as samples and reagents. The conversion of D₄ to PDMS was clearly observed and was explained through the interaction with anionic species present in the mixture.

It is to be noted that all ranges detailed herein include the endpoints. Numerical values from different ranges are combinable.

The transition term comprising encompasses the transition terms “consisting of” and “consisting essentially of”.

The term “and/or” includes both “and” as well as “or”. For example, “A and/or B” is interpreted to be A, B, or A and B.

While the invention has been described with reference to some embodiments, it will be understood by those skilled in the art that various changes may be made and equivalents may be substituted for elements thereof without departing from the scope of the invention. In addition, many modifications may be made to adapt a particular situation or material to the teachings of the invention without departing from essential scope thereof. Therefore, it is intended that the invention not be limited to the particular embodiments disclosed as the best mode contemplated for carrying out this invention, but that the invention will include all embodiments falling within the scope of the appended claims.

What is claimed is:

1. An impact modified composition comprising:
a first polymer; and
a second polymer that is dispersed in the first polymer; where the first polymer and the second polymer are melt polymerized in each other's presence, are phase separated from each other after polymerization; are not reactively bonded with each other; and where a precursor to the first polymer and to the second polymer are soluble in one another prior to polymerization.

2. The composition of claim 1, having a compressive modulus of 2500 to 3500 MPa, a yield stress of 85 to 100, and a fracture toughness of 10 to 100 kilojoules per meter.

3. The composition of claim 1, having a fracture toughness of 35 to 60 kilojoules per meter.

4. The composition of claim 1, having void diameters that of 0.01 to 10 micrometers and where an area void fraction as determined from scanning electron microscopy is 0.02 to 0.15, based on a total cross-sectional area of a fractured surface of the composition when it is fractured at a temperature below its glass transition temperature.

5. The composition of claim 1, where the first polymer is anionically polymerized.

6. The composition of claim 1, where the first polymer is a thermoplastic polymer or a thermoset polymer.

7. The composition of claim 6, where the thermoplastic polymer is a polyacetal, a polyolefin, a polyacrylic, a polycarbonate, a polystyrene, a polyester, a polyamide, a polyamideimide, a polyarylate, a polyarylsulfone, a polyethersulfone, a polyphenylene sulfide, a polyvinyl chloride, a polysulfone, a polyimide, a polyetherimide, a polyfluoroethylene, a polyetherketone, a polyether etherketone, a polyether ketone ketone, a polybenzoxazole, a polyphthalide, a polyacetal, a polyanhydride, a polyvinyl ether, a polyvinyl thioether, a polyvinyl alcohol, a polyvinyl ketone, a polyvinyl halide, a polyvinyl nitrile, a polyvinyl ester, a polysulfonate, a polysulfide, a polythioester, a polysulfone, a polysulfonamide, a polyurea, a polyphosphazene, a polysilazane, or a combination comprising at least one of the foregoing thermoplastic polymers and where the thermoset polymer is an epoxy polymer, an unsaturated polyester polymer, a polyimide, a bismaleimide, a bismaleimide triazine polymer, a cyanate ester polymer, a benzoxazine polymer, a benzocyclobutene polymer, an acrylic, an alkyd, a phenol-formaldehyde polymer, a novolac, a resole, a melamine-formaldehyde polymer, a urea-formaldehyde polymer, a hydroxymethylfuran, an isocyanate, a diallyl phthalate, a triallyl cyanurate, a triallyl isocyanurate, an unsaturated polyesterimide, or a combination comprising at least one of the foregoing thermosetting polymers.

8. The composition of claim 1, where the second polymer is an oligomer that has less than 30 repeat units.

9. The composition of claim 1, where the second polymer is an elastomer; where the elastomer is a polybutadiene, a polyisoprene, a polydiorganosiloxane, a polychloroprene, or a combination thereof.

10. The composition of claim 1, where the first polymer is a polyamide and where the second polymer is a polydiorganosiloxane.

11. The composition of claim 1, where the second polymer is present in an amount of 0.1 to 20 wt %, based on the total weight of the impact modified composition.

12. The composition of claim 11, where the second polymer is present in an amount of 1 to 4 wt %, based on the total weight of the impact modified composition.

13. An article manufactured from the composition of claim 1.

14. A method comprising:
melt polymerizing a first monomer and a second monomer in the presence of each other to form a first polymer and a second polymer;
where the first monomer and the second monomer are soluble in each other;
where first polymer and the second polymer are phase separated from each other with the second polymer being dispersed in the first polymer; where the first polymer and the second polymer are not reactively bonded to each other.

15. The method of claim 14, further comprising molding the impact modified composition.

16. The method of claim 15, where the molding is reactive injection molding.
